(19) United States
(12) Patent Application Publication
(10) Pub. No.: US 2026/0367593 A1
(43) Pub. Date: Nov. 19, 2026

(54) FISH APPETITE ESTIMATION

(71) Applicant: TidalX AI Inc., Mountain View, CA (US)

(72) Inventors: Michael Anthony Russo, Foster City, CA (US); Cory Drew Schillaci, Berkeley, CA (US); Ryan Heacock, London (GB)

(21) Appl. No.: 19/295,364

(22) Filed: Aug. 8, 2025

Related U.S. Application Data
(60) Provisional application No. 63/680,951, filed on Aug. 8, 2024.

(51) Int. Cl. G05B 13/04; A01K 61/80

(52) U.S. Cl. CPC G05B 13/048; A01K 61/80

(57) ABSTRACT

Methods, systems, and apparatus, including computer programs encoded on computer storage media, for fish appetite estimation. One of the methods includes providing to a model trained to predict a feed rate for fish, (i) sensor data indicative of a feeding rate of fish in a fish pen and (ii) historical data representative of feeding trends for the fish; obtaining an output feed rate from the model; and generating one or more control signals configured to adjust a feeding system of the fish pen in accordance with the output feed rate.

### CROSS-REFERENCE TO RELATED APPLICATIONS

This application claims the benefit of U.S. Provisional Application No. 63/680,951, filed Aug. 8, 2024, the contents of which are incorporated by reference herein.

### FIELD

This specification generally relates to marine monitoring systems for environmentally sustainable aquaculture.

### BACKGROUND

Researchers and fish farm operators face several challenges when feeding fish. Providing more food than what is required for normal growth may result in food waste, environmental damage, as well as a corresponding increase in food expenses. Alternatively, providing less food than what is required for normal growth may affect the health of farmed fish, and may reduce the quality of the final product.

A manual process of observing and adjusting feed provided to fish is often used to monitor feeding levels, but this approach requires workers to be on site to monitor fish pen activity. Such a manual process is often time-consuming, expensive, and has several limitations, such as when cameras used to monitor fish activity are not correctly positioned or when adverse weather conditions decrease the availability of human observers.

### SUMMARY

In general, innovative aspects of the subject matter described in this specification relate to a feeding system for fish in aquaculture. Although described in reference to use in aquaculture, the techniques described in this document can be applied to other animal feeding situations, including livestock or agriculture.

In some implementations, a system implementing techniques described in this document can track a real time estimate of a feed rate—such as a maximum feed rate—to be consumed by fish without pellet fall through during a meal, where pellet fall through refers to food falling out of a pen containing fish. For example, the system can generate an estimate of a feed rate based on real time signals from underwater sensors and predictive analytics based on historical trends.

Some examples of real time visual signals can include depth correlated pellet counts and fish behavioral patterns. Historical signals can include appetite trends from recent meals with the same group of fish or estimates of appetite based on fish biomass, season, weather, among other data. Historic signals can include data from historical data across one or more groups of fish over time. Estimates of feed rate can be used by a feeding system to bound a safe feed rate which can be useful for minimizing environmental and economic impacts of overfeeding. In some implementations, techniques described in this document estimate an optimal maximum feed rate based on a fish appetite prediction. For example, using data such as visual signals from sensors or previously stored data, systems described can predict an appetite of fish. A feed rate can be adjusted to maximize feeding of the fish while minimize environmental and economic impacts of overfeeding.

In general, one aspect of the subject matter described in this specification can be embodied in methods that include the actions of providing to a model trained to predict a feed rate for fish, (i) sensor data indicative of a feeding rate of fish in a fish pen and (ii) historical data representative of feeding trends for the fish; obtaining an output feed rate from the model; and generating one or more control signals configured to adjust a feeding system of the fish pen in accordance with the output feed rate.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, the feeding system of the fish pen provides food to one or more fish in the fish pen. In some implementations, the sensor data comprises one or more images of fish in the fish pen. In some implementations, the one or more images of the fish in the fish pen are obtained from a camera positioned underneath the fish in the fish pen. In some implementations, the sensor data include results generated from raw sensor data. In some implementations, the results include an indication of a number of fish mouths open. In some implementations, the historical data include prior feed rates of the fish pen.

The subject matter described in this specification can be implemented in various implementations and may result in one or more of the following advantages. Techniques described, including estimating fish appetite and feed rate, allows animal feeding systems to adjust for the amount of feed needed by animals while limiting overfeeding and underfeeding-both of which can harm animals as well as the environment. In some cases, excess feed falling in an aquaculture environment can harm natural wildlife leading to algae blooms among other environmental damage. Another advantage of the described techniques include improvements in sensor placement. Optimal sensor placement can change depending on a feeding status of fish. Fish pens can be large and fish appetite predictions can help determine where to place cameras or other sensors to best observe fish feeding.

For example, by predicting appetite, sensors can be moved preemptively to locations within a fish pen-e.g., underneath fish, to the side of fish, among others.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example system for fish appetite estimation.

FIG. 2A is a comparison of uniform and non-uniform swimming.

FIG. 2B is a trend of fish density in an enclosure.

FIG. 3 is a flow diagram of an example process for fish appetite estimation.

Like reference numbers and designations in the various drawings indicate like elements.

### DETAILED DESCRIPTION

Techniques described in this document include systems for fish appetite estimation. The systems, such as the system 100, can be trained to detect features of hungry or non-hungry fish and adjust—e.g., increase or decrease—feed provided to the fish accordingly. In a fish farming environment, the systems described in this document can increase a feed rate to a maximum level, or a level set by the system or user, as long as the systems detects the fish have an appetite for food—e.g., a quantity of food to be provided at a maximum feed rate level.

The systems can make predictions, e.g., based on observed data of the fish, to adjust feed preemptively to counteract lag in a feeding system, such as a 2 minute delay from when a feed adjustment signal is provided to a feeding system and when the feed provided to the fish changes according to the feed adjustment signal. Lag can exist due to length of pipes that carry feed to fish and the desire to clear the feed pipes—e.g., not let feed sit in the pipes. Techniques described offer the benefit of preemptive feeding adjustment. Techniques also offer the benefit of allowing autonomous or semi-autonomous feeding control thereby increasing periods where fish can be fed—e.g., to when no or few personnel are available—or reducing personnel required to manage feeding.

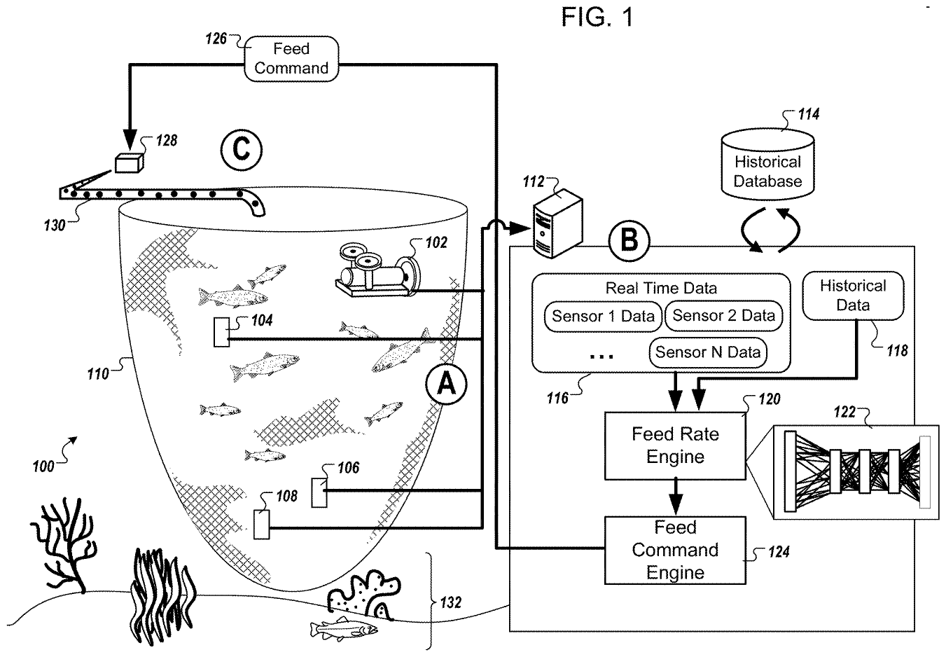

FIG. 1 is an example system 100 for fish appetite estimation. The system 100 includes sensors 102, 104, 106, and 108, a controller 112, and a feeding system 128. The controller 112 is communicably connected to the sensors 102, 104, 106, and 108. The sensors 102, 104, 106, and 108 can include visual sensors, LIDAR sensors, acoustic sensors, among others. The sensors 102, 104, 106, and 108 can be stationary or configured to move within fish pen 110.

In general, FIG. 1 shows the controller 112 obtaining sensor input from the sensors 102, 104, 106, and 108 and using the sensor input to adjust the feeding system 128 and the resulting feed provided to the fish pen 110. The sensors 102, 104, 106, and 108 obtain sensor data of the fish pen 110—e.g., fish included in the fish pen 110, feed being provided to the fish pen 110, temperature, salinity, among other data.

For ease of description, FIG. 1 is described in stages A through C. In some implementations, stages occur in a different order from that described herein—e.g., stage B followed by stage A; stage B occurring simultaneously, or at least partially in parallel with processes of stage A; among others.

In stage A of the example of FIG. 1, the sensors 102, 104, 106, and 108 obtain sensor data from the fish pen 110. The sensors 102, 104, 106, and 108 can include one or more visual sensors, acoustic sensors, among others. The sensors 102, 104, 106, and 108 can move using propellers, winches, ropes, be stationary, or attached to elements of the fish pen 110—shown as a net enclosure but implementations of the feeding and estimation techniques described in this document can be used with any type of enclosure or animals therein.

In some implementations, more or fewer sensors are used to obtain data.

For example, instead of 4 sensors, 5 sensors can be used, or 2 sensors, or 1 sensor. In general, any number of sensors can be used to obtain sensor data of the animals to be provided, or currently being provided feed. In some implementations, the controller 112 estimates an appetite of the fish during a feeding session. In some implementations, the controller 112 estimates an appetite of the fish before a feeding session.

In stage B, the controller 112 obtains data from the sensors 102, 104, 106, and 108. The data from the sensors 102, 104, 106, and 108 can be obtained as real time data 116. The real time data 116 can include data from sensors 1 to N where N represents the number of sensors that obtain sensor data to be processed by the controller 112.

In some implementations, the controller 112 obtains historical data 118 in addition to, or instead of, the real time data 116. For example, the controller 112 can obtain the historical data 118 from historical database 114. The historical database 114 can be a memory storage device communicably connected to the controller 112. The historical database 114 can include data of one or more groups of fish. The one or more groups of fish can include the group currently in the fish pen 110 or other groups of fish from other pens or enclosures.

In some implementations, the controller 112 provides the historical data 118 and the real time data 116 to the feed rate engine 120. In some implementations, the feed rate engine 120 includes a machine learning model. For example, the feed rate engine 120 can include one or more fully connected layers or convolutional layers, among other neural network structures configured to output an indication adjusting feed based on input signals.

Potential input signals for appetite estimate can include data obtained from one or more of the sensors 102, 104, 106, and 108 and include one or more of the following. The following values can be determined using data from the sensors 102, 104, 106, and 108 and expressed as a collection of one or more data values—e.g., a vector of input values for a trained model of the feed rate engine 120.

Example input signals:

(1) Pellet counts—e.g., observations by a visual camera of pellets at specific depths. Images can indicate fish appetite is lower than a current feed rate, such as when food pellets drop below a threshold depth. (2) Fish schooling or swimming patterns—e.g., fish may swim in large circles near the edge of a pen when satiated but in tight circles around the feed column when appetite is high, fish may swim at a steady speed when appetite is low but occasionally dart through the water when appetite is high and they are searching for feed. When appetite is high, fish can tend to swim in a chaotic way, e.g., rather than in a general circular motion. Tight circles might apply to tuna or other fish species. Chaotic swimming can indicate high appetite in some species of salmon. In general, sensor data and model output can depend on a species being observed. Specific species models can be trained or a species can be provided as input to a model trained across two or more species of animal. (3) Actual feed rates from the prior day(s) for this group of fish—e.g., a total amount and rate at which fish will consume food may change only slightly from day to day in the absence of abrupt environmental changes. A prior day's actual meal duration, feed rate, and total feed amounts can provide strong priors for today's appetite.

(4) Actual feed rates from other meals at nearby pens earlier in the day—e.g., when nearby pens are not fed simultaneously, or the start of meals is staggered, the actual feed rate at nearby pens may serve as a prior for fish appetite. (5) Environmental factors—e.g., water temperature, length of day, dissolved oxygen and other environmental factors can correlate with fish appetite. The amount of ambient light, influenced by time of day, day of the year and weather can affect fish appetite. (6) Seasonal variation—e.g., some fish species such as salmon are known to show periodic annual variation in appetite. (7) Veterinary treatment or other farmer interventions—e.g., fish can be traumatized by veterinary treatments (e.g., for sea lice) or other farmer interventions (e.g., grading or partial harvests). Fish can show qualitatively different patterns, such as starting with a low appetite and taking longer to increase their appetite during a meal. They may also show substantially reduced appetite after trauma.

(8) Fish biomass—e.g., fish weight is a primary indicator of fish appetite (bigger fish eat more). One or more of the sensors 102, 104, 106, and 108 can provide sensor data indicating one or more fish. The controller 112 can process the sensor data to determine one or more fish biomass measurements and use the estimated fish biomass measurements as input to a model of the feed rate engine 120 to determine a feed rate.

(9) Fish welfare—e.g., the controller 112 can determine a health of one or more fish, such as through movement behavior, appearance, weight, among others. Poor fish health can reduce fish appetite.

(10) Mouth gape—e.g., mouth open; the controller 112 can determine, using sensor data such as image data from a visual sensor of the sensors 102, 104, 106, and 108, a ratio or number of fish with mouths open. Fish with mouths open can indicate fish with appetite for additional feed.

(11) Curved fish detector—e.g., in general, fish are willing to expend more energy when hunting for food. Higher percentages of curved fish can indicate higher appetite. In some implementations, sensors capture images from below against the sky indicating fish curved.

(12) Vertically swimming fish—e.g., as noted, fish are generally willing to expend more energy when hunting for food. Higher percentages of vertically swimming fish can indicate higher appetite. In some implementations, sensors capture images of side views of fish which can be used to determine vertically swimming fish. An input signal can include a number of fish vertically swimming, a ratio of detected fish that are determined to be vertical, among others. In some implementations, vertical swimming fish include approximately vertical fish, e.g., fish within a threshold angle of 90 degrees relative to a horizontal swimming direction.

(13) Average swimming speed—e.g., because fish are generally willing to expend more energy when hunting for food, greater swimming speed indicates greater appetite. A model of the feed rate engine 120 can be trained to indicate a higher estimated appetite, other factors being equal, in situations where an average swimming speed is higher. In some implementations, the controller 112 determines swimming speed by comparing one or more images of fish—e.g., frame to frame.

For example, image distance can be translated to actual distance and, when compared with a difference in time—e.g., using a timestamp of the frames—the controller 112 can determine a speed of a fish. The controller 112 can combine multiple speeds to determine an average for a group of fish. In some implementations, individual speeds are used for input to one or more models of the feed rate engine 120.

(14) Detecting actual pellet consumption—e.g., often a camera is in the middle of feeding and can directly detect pellet consumption in either the top or sideways facing cameras.

(15) Fish striking—e.g., similar to the above, sensors can detect fish striking at their feed pellets. This behavior can be detected from a distance even if the feed itself is not detected—e.g., by movement of the fish.

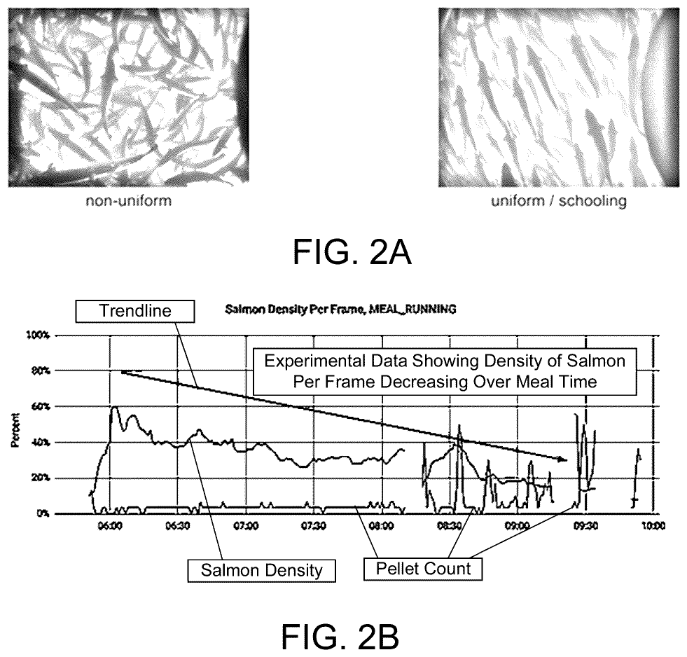

(16) Chaos/hornets nest detection—e.g., non-uniform swimming behaviors can indicate high appetite directly. Non-uniform swimming behavior can resemble a “hornets nest” where fish are not generally swimming in the same direction, such as around in a circular pattern. In some implementations, the system 100 uses a snapshot single frame (e.g., from a top camera, looking up) and use instantaneous fish head angle to estimate chaos. For example, the controller 112 can obtain sensor data that includes an image of fish from below the fish or above the fish, depending on implementation. The controller 112 can determine a number of fish in the image and determine a fish head angle for the number of fish. In some implementations, a threshold number fish with different angle—e.g., greater than a threshold difference—indicates non-uniform swimming. A comparison of uniform and non-uniform swimming is shown in FIG. 2A.

In some implementations, uniform schooling behavior is not a signal of appetite (e.g., not a negative signal). In some implementations, only chaos or non-uniform swimming is a positive signal for where it is located within the pen. For example, the controller 112 can determine one or more locations in the fish pen 110 indicating non-uniform swimming and one or more locations in the fish pen 110 indicating uniform swimming. The controller 112 can use the one or more locations and determinations of uniform or non-uniform swimming as an input signal, among one or more other input signals, to the feed rate engine 120.

(17) Fish density over time—e.g., the controller 112 can determine a density of fish within one or more images of fish captured by the sensors 102, 104, 106, and 108. In some implementations, the controller 112 detects how much sky is visible in images taken from beneath one or more fish. For example, one or more of the sensors 102, 104, 106, and 108 can obtain images of fish from beneath the fish. A background of the fish can be sky or light coming from the surface of water above the sensor. A color or pixel value can be associated with fish and a pixel value can be associated with non-fish. By determining a ratio of fish pixels to non-fish pixels, the controller 112 can determine a density of fish in one or more images. Subtle changes in this density over time can indicate changes in appetite. Changes can often be imperceptible to humans (e.g., 5-10% change in average fish density over 15 minutes is difficult for a human observer to notice). But the controller 112 can determine density and track historical values to determine trends—e.g., as shown in FIG. 2B

(18) Fish startle events—e.g., instances of fish moving or scattering outside of a feed zone. Density trends mentioned above or other sensor data can be used by the controller 112 to determine startle events. Startle events can cause an instantaneous decrease in appetite.

In some implementations, the feed rate engine 120 generates a feed rate. For example, the feed rate can indicate an amount of feed to be provided to the fish pen 110 in a given amount of time.

In some implementations, the controller 112 trains one or more models of the feed rate engine 120. For example, the controller 112 can compare estimates of fish appetite, indicated by a feed rate, to feed rates generated by trained workers.

The controller 112 can adjust one or more weights of the models of the feed rate engine 120 to approximate feed rates generated by trained workers. The controller 112 can adjust one or more weights of the models of the feed rate engine 120 to minimize pellet fall through and account for the various inputs described in this document.

In stage C, a feed command engine 124 of the controller 112 obtains an indication of a feed rate from the feed rate engine 120. The feed command engine 124 can generate and send a communication signal to the feeding system 128. The communication signal can be configured to adjust feed being provided by the feeding system 128 to the fish pen 110.

In some implementations, the feeding system 128 is located on land or some distance away from the fish pen 110. The distance between the feeding system 128 and the fish pen 110 can cause delay in signals to adjust feed and the actual adjustment being realized as a change in feed being received at the fish pen 110. It is for this reason that estimating, in advance, a future appetite of fish can be important. Because of the lag in control signal, the controller 112 can estimate what the appetite of fish in the fish pen 110 will be at a future time and then account for the lag in provided feed from the feeding system 128. For example, the controller 112 can estimate an appetite of fish in the fish pen 110 to be 10 pounds of feed in 1 minute for the next 30 seconds but 5 pounds of feed in 1 minute for the following 30 seconds. Accounting for a lag of 30 seconds between the feeding system 128 and the fish pen 110, the controller 112 can send a signal to the feeding system 128 configured to adjust a feed rate of the fish pen 110 to match an estimated 5 pounds of feed in 1 minute beforehand to account for lag in the food travelling from the feeding system 128 to the fish pen 110.

The feed command 126 can indicate a feed adjustment to be performed by the feeding system 128 an amount of time before such a feeding change is required based on estimated appetites in the fish pen 110. For example, if feed provided by the feeding system 128 takes 20 seconds to reach the fish pen 110, the controller 112 can generate feed adjustment commands configured to adjust feed at the feeding system 128 20 seconds before a corresponding appetite-estimated by the controller 112—would require such a change. In this way, the techniques described can improve on feedback systems which do not account for lag in a feeding system provisioning and which therefore can waste feed at the end of a feeding session—e.g., because fish are too full to eat more.

In some implementations, feed adjustment reduces feed fall through which can harm wildlife 132. For example, as a non-native environmental element, excess feed falling from the fish pen 110 can harm the wildlife 132 below. Such harm can include killing indigenous species of plants and animals. Techniques described in this document can help prevent damage to the wildlife by reducing feed fall through and food waste.

The controller 112 is an example of a system implemented as computer programs on one or more computers in one or more locations, in which the systems, components, and techniques described in this specification are implemented. The system 100 can include user devices such as personal computers, mobile communication devices, and other devices that can send and receive data over a network. The network (not shown), such as a local area network (“LAN”), wide area network (“WAN”), the Internet, or a combination thereof, can connect the feeding system 128, the sensors 102, 104, 106, and 108, and the controller 112. The controller 112 can use a single computer or multiple computers operating in conjunction with one another, including, for example, a set of remote computers deployed as a cloud computing service.

The controller 112 can include several different functional components, including the feed rate engine 120 and the feed command engine 124. The feed rate engine 120 and the feed command engine 124 or a combination of these, can include one or more data processing apparatuses, can be implemented in code, or a combination of both. For instance, each of the feed rate engine 120 and the feed command engine 124 can include one or more data processors and instructions that cause the one or more data processors to perform the operations discussed herein.

The various functional components of the system 100 can be installed on one or more computers as separate functional components or as different modules of a same functional component. For example, the feed rate engine 120 and the feed command engine 124 of the system 100 can be implemented as computer programs installed on one or more computers in one or more locations that are coupled to each through a network. In cloud-based systems for example, these components can be implemented by individual computing nodes of a distributed computing system.

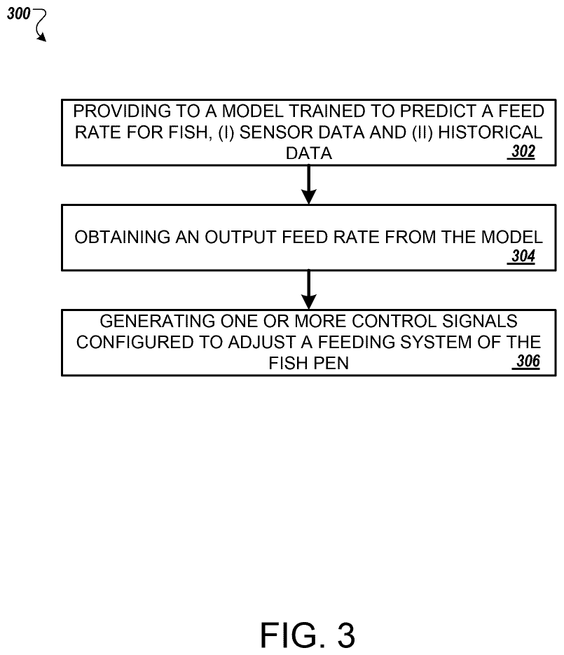

FIG. 3 is a flow diagram of an example process 300 for fish appetite estimation. For example, the process 300 can be used by the system 100.

The processing 300 includes providing to a model trained to predict a feed rate for fish, (i) sensor data and (ii) historical data (302). For example, the controller 112 can generate sensor data using data obtained from the sensors 102, 104, 106, and 108. The controller 112 can generate historical data obtained from the historical database 114. The controller 112 can provide both the (i) sensor data and (ii) historical data to the feed rate engine 120. The feed rate engine 120 can include one or more models trained predict a feed rate for fish.

Sensor data can include one or more images of fish. In some implementations, images are obtained from a camera positioned underneath the fish in the fish pen. For example, silhouettes created by the fish and light from above water can help make fish detections more reliable compared to downward views. Underneath views can also be helpful in determining crowding or other features of fish grouping which can be used as indications for appetite or feed control.

In some implementations, instead of obtaining images from cameras positioned underneath fish, the process 300 can include obtaining images from other angles. This sensor data can be provided to the model trained to predict a feed rate or feed adjustment. For example, the controller 112 can obtain images from camera sensors positioned beside one or more fish or oriented facing sideways in the fish pen (e.g., looking at fish from the side).

In some implementations, sensor data includes results generated from raw sensor data. For example, the controller 112 can obtain images from one or more camera sensors. The controller 112 can process the images to generate results.

Results can include a number of fish mouths open—e.g., determined using visual algorithms that process images captured in a fish pen. Results can include other information—e.g., a number of fish detected, a number of pellets detected, one or more angles of salmon, among others.

The processing 300 includes obtaining an output feed rate from the model (304). For example, the controller 112 can obtain an output feed rate from one or more models of the feed rate engine 120. The controller 112 can provide one or more input signals to the feed rate engine 120. The input signals can be provided to an input layer of a model used by the feed rate engine 120 to generate an output feed rate.

The processing 300 includes generating one or more control signals configured to adjust a feeding system of the fish pen (306). For example, the feed command engine 124 can generate the feed command 126 and transmit the feed command 126 to the feeding system 128. The feed command 126 can be configured to adjust a rate of feed provided to the fish pen 110—e.g., to account for time difference between future predicted appetite changes and lag in feed being provided to the fish pen 110.

In some implementations, the controller 112 trains one or more models of the feed rate engine 120. For example, the controller 112 uses feedback signals—e.g., indicating feed fall through or other features of a feeding session—to determine if feed rates set based on estimate appetites were correct. The controller 112 can adjust one or more weights or parameters of one or more models of the feed rate engine 120 to adjust for overfeeding or underfeeding as detected by the controller 112 following feed changes made in accordance with appetite estimates from the feed rate engine 120.

The order of operations in the process 300 described above is illustrative only and can be performed in different orders. In some implementations, the process 300 can include additional operations, fewer operations, or some of the operations can be divided into multiple operations.

In some implementations, techniques described are performed by an entirely self-contained local system. For example, a self-contained local system can include systems that do not have internet connections or external GPU processing. The system can include one or more processors configured to operate one or more models for estimating fish appetite and to adjust a feeding system using one or more values indicating the estimated fish appetite. Local systems could be an advantage for remote fish farms. All, or a majority, of computation could be done and acted upon locally. The local system could include a remotely operated vehicle, e.g., sensor 102. The local system can have access to feeding hardware to dispense feed for fish.

A number of implementations have been described. Nevertheless, it will be understood that various modifications may be made without departing from the spirit and scope of the disclosure. For example, various forms of the flows shown above may be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer.

Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular implementations of the invention have been described. Other implementations are within the scope of the following claims. For example, the operations recited in the claims, described in the specification, or depicted in the figures can be performed in a different order and still achieve desirable results. In some cases, multitasking and parallel processing may be advantageous.

What is claimed is:

1. A system comprising one or more computers and one or more storage devices on which are stored instructions that are operable, when executed by the one or more computers, to cause the one or more computers to perform operations comprising:
providing to a model trained to predict a feed rate for fish, (i) sensor data indicative of a feeding rate of fish in a fish pen and (ii) historical data representative of feeding trends for the fish;
obtaining an output feed rate from the model; and
generating one or more control signals configured to adjust a feeding system of the fish pen in accordance with the output feed rate.

2. The system of claim 1, wherein the feeding system of the fish pen provides food to one or more fish in the fish pen.

3. The system of claim 1, wherein the sensor data comprises one or more images of fish in the fish pen.

4. The system of claim 3, wherein the one or more images of the fish in the fish pen are obtained from a camera positioned underneath the fish in the fish pen.

5. The system of claim 1, wherein the sensor data include results generated from raw sensor data.

6. The system of claim 5, wherein the results include an indication of a number of fish mouths open.

7. The system of claim 1, wherein the historical data include prior feed rates of the fish pen.

8. A computer-implemented method that comprises:
providing to a model trained to predict a feed rate for fish, (i) sensor data indicative of a feeding rate of fish in a fish pen and (ii) historical data representative of feeding trends for the fish;
obtaining an output feed rate from the model; and
generating one or more control signals configured to adjust a feeding method of the fish pen in accordance with the output feed rate.

9. The method of claim 8, wherein the feeding method of the fish pen provides food to one or more fish in the fish pen.

10. The method of claim 8, wherein the sensor data comprises one or more images of fish in the fish pen.

11. The method of claim 10, wherein the one or more images of the fish in the fish pen are obtained from a camera positioned underneath the fish in the fish pen.

12. The method of claim 8, wherein the sensor data include results generated from raw sensor data.

13. The method of claim 12, wherein the results include an indication of a number of fish mouths open.

14. The method of claim 8, wherein the historical data include prior feed rates of the fish pen.

15. One or more non-transitory computer storage media encoded with instructions that, when executed by one or more computers, cause the one or more computers to perform operations comprising:
providing to a model trained to predict a feed rate for fish, (i) sensor data indicative of a feeding rate of fish in a fish pen and (ii) historical data representative of feeding trends for the fish;
obtaining an output feed rate from the model; and
generating one or more control signals configured to adjust a feeding media of the fish pen in accordance with the output feed rate.

16. The media of claim 15, wherein the feeding media of the fish pen provides food to one or more fish in the fish pen.

17. The media of claim 15, wherein the sensor data comprises one or more images of fish in the fish pen.

18. The media of claim 17, wherein the one or more images of the fish in the fish pen are obtained from a camera positioned underneath the fish in the fish pen.

19. The media of claim 15, wherein the sensor data include results generated from raw sensor data.

20. The media of claim 19, wherein the results include an indication of a number of fish mouths open.
